(19) United States
(12) Patent Application Publication
(10) Pub. No.: US 2020/0356154 A1
(43) Pub. Date: Nov. 12, 2020

(54) ELECTRONIC APPARATUS, CONTROL METHOD, AND PROGRAM

(71) Applicant: LENOVO (SINGAPORE) PTE. LTD., SINGAPORE (SG)

(72) Inventor: Kazuhiro Kosugi, YOKOHAMA (JP)

(73) Assignee: LENOVO (SINGAPORE) PTE. LTD., SINGAPORE (SG)

(21) Appl. No.: 16/776,484

(22) Filed: Jan. 29, 2020

(30) Foreign Application Priority Data
May 8, 2019 (JP) 2019088005

(51) Int. Cl. G06F 1/3206; G06F 1/3296; G06K 9/00; G06F 21/32

(52) U.S. Cl. CPC G06F 1/3206; G06F 1/3296; G06F 21/32; G06K 9/00268; G06K 9/00228

(57) ABSTRACT

An electronic apparatus includes: a system processing unit which executes system processing based on a system; a person detection unit which takes a first time to detect a change from a first detection state in which a person is present within a predetermined detection range to a second detection state in which no person is present, and outputs first detection information at timing in the middle of the first time; and an operating state control unit which performs pre-notification processing corresponding to the first detection information based on the first detection information output from the person detection unit, and causes an operating state of the system to make a transition to a first operating state, in which at least part of the system processing is limited, after a second time has elapsed since the start of the pre-notification processing.

### FIELD OF THE INVENTION

The present invention relates to an electronic apparatus, a control method, and a program.

### BACKGROUND OF THE INVENTION

There is an electronic apparatus which makes a transition to a usable state when a person approaches and to a standby state in which functions except some of the functions are stopped when the person leaves (for example, see Japanese Unexamined Patent Application Publication No. 2016-148895).

### SUMMARY OF THE INVENTION

However, a person using an electronic apparatus is not always staying neatly in front of the electronic apparatus and tends to move freely. Therefore, when the leave of the person from the electronic apparatus is detected, there is a possibility to detect the leave of the person erroneously due to changes in posture of the person or the like despite the fact that the person is using the electronic apparatus, and hence to make a transition to a standby state.

The present invention has been made in view of the above circumstances, and it is an object thereof to provide an electronic apparatus, a control method, and a program capable of controlling an operating state properly according to the presence or absence of a person.

The present invention has been made to solve the above problem, and an electronic apparatus according to the first aspect of the present invention includes: a system processing unit which executes system processing based on a system; a person detection unit which takes a first time to detect a change from a first detection state in which a person is present within a predetermined detection range to a second detection state in which no person is present, and outputs first detection information at a time within the first time; and an operating state control unit which performs pre-notification processing corresponding to the first detection information based on the first detection information output from the person detection unit, and causes an operating state of the system to make a transition to a first operating state, in which at least part of the system processing is limited, after a second time has elapsed since the start of the pre-notification processing.

The above electronic apparatus may also be such that, when detecting the first detection state in which the person is present within the predetermined detection range during a period of time from outputting the first detection information until the second time has elapsed, the person detection unit outputs second detection information indicating that the first detection state is detected, and based on the second detection information output from the person detection unit, the operating state control unit stops the pre-notification processing and cancels the transition of the operating state of the system to the first operating state.

The above electronic apparatus may further be such that the person detection unit has a distance sensor capable of detecting distance to an object in respective detection modes of a first detection mode and a second detection mode higher in detection accuracy than the first detection mode, the person detection unit detects a change from the first detection state to the second detection state based on detection results in the second detection mode, and after the second time has elapsed, the person detection unit switches the detection mode of the distance sensor from the second detection mode to the first detection mode.

Further, the above electronic apparatus may be such that the person detection unit takes the first time to detect changes in the distance changing according to breathing of the person present within the predetermined detection range based on the detection results in the second detection mode in order to detect whether the person is present within the predetermined detection range or not.

Further, the above electronic apparatus may be such that the end of the second time is set later than the end of the first time.

Further, the above electronic apparatus may be such that a length of the second time is settable by a user.

An electronic apparatus according to the second aspect of the present invention includes: a system processing unit which executes system processing based on a system; a person detection unit having a distance sensor capable of detecting distance to an object in respective detection modes of a first detection mode and a second detection mode higher in detection accuracy than the first detection mode to detect, based on detection results in the second detection mode, a change from a first detection state in which a person is present within a predetermined detection range to a second detection state in which no person is present, and output detection information based on the detection; and an operating state control unit which performs pre-notification processing corresponding to the detection information based on the detection information output from the person detection unit, and causes an operating state of the system to make a transition to a first operating state, in which at least part of the system processing is limited, after a second time has elapsed since the start of the pre-notification processing, wherein the person detection unit switches the detection mode of the distance sensor from the second detection mode to the first detection mode after the second time has elapsed.

A control method according to the third aspect of the present invention is a control method for an electronic apparatus configured to include a system processing unit which executes system processing based on a system, the control method including: a person detection step of causing a person detection unit to take a first time to detect a change from a first detection state in which a person is present within a predetermined detection range to a second detection state in which no person is present, and to output first detection information at timing within the first time; and an operating state control step of causing an operating state control unit to perform pre-notification processing corresponding to the first detection information based on the first detection information output in the person detection step, and to cause an operating state of the system to make a transition to a first operating state, in which at least part of the system processing is limited, after a second time has elapsed since the start of the pre-notification processing.

A control method according to the fourth aspect of the present invention is a control method for an electronic apparatus configured to include: a system processing unit which executes system processing based on a system; and a distance sensor capable of detecting distance to an object in respective detection modes of a first detection mode and a second detection mode higher in detection accuracy than the first detection mode, the control method including: a person detection step of causing a person detection unit to detect a change from a first detection state in which a person is present within a predetermined detection range to a second detection state in which no person is present based on detection results in the second detection mode, and to output detection information based on the detection to the system processing unit; and an operating state control step of causing an operating state control unit to perform pre-notification processing corresponding to the detection information based on the detection information output in the person detection step, and to cause an operating state of the system to make a transition to a first operating state, in which at least part of the system processing is limited, after a second time has elapsed since the start of the pre-notification processing, wherein in the person detection step, the detection mode of the distance sensor is switched from the second detection mode to the first detection mode after the second time has elapsed.

A program according to the fifth aspect of the present invention is a program for an electronic apparatus configured to include a system processing unit which executes system processing based on a system, the program causing a computer as the electronic apparatus to execute: a person detection step of taking a first time to detect a change from a first detection state in which a person is present within a predetermined detection range to a second detection state in which no person is present, and outputting first detection information within the first time; and an operating state control step of performing pre-notification processing corresponding to the first detection information based on the first detection information output in the person detection step, and causing an operating state of the system to make a transition to a first operating state, in which at least part of the system processing is limited, after a second time has elapsed since the start of the pre-notification processing.

A program according to the sixth aspect of the present invention is a program for an electronic apparatus configured to include: a system processing unit which executes system processing based on a system; and a distance sensor capable of detecting distance to an object in respective detection modes of a first detection mode and a second detection mode higher in detection accuracy than the first detection mode, the program causing a computer as the electronic apparatus to execute: a person detection step of detecting a change from a first detection state in which a person is present within a predetermined detection range to a second detection state in which no person is present based on detection results in the second detection mode, and outputting detection information based on the detection to the system processing unit; and an operating state control step of performing pre-notification processing corresponding to the detection information based on the detection information output in the person detection step, and causing an operating state of the system to make a transition to a first operating state, in which at least part of the system processing is limited, after a second time has elapsed since the start of the pre-notification processing, wherein in the person detection step, the detection mode of the distance sensor is switched from the second detection mode to the first detection mode after the second time has elapsed.

The above-described aspects of the present invention can control an operating state properly according to the presence or absence of a person.

### BRIEF DESCRIPTION OF THE DRAWINGS

FIGS. 1A-1C are diagrams for describing an outline of HPD processing of an electronic apparatus according to a first embodiment.

FIG. 2 is a diagram illustrating an outline of standby-state transition processing according to the first embodiment.

FIG. 3 is a perspective view illustrating an external structure example of the electronic apparatus according to the first embodiment.

FIG. 4 is a schematic diagram illustrating a sensor detection range of a proximity sensor.

FIG. 5 is a schematic block diagram illustrating a configuration example of the electronic apparatus according to the first embodiment.

FIG. 6 is a graph illustrating an example of a distance variation associated with the breathing of a person.

FIG. 7 is a graph illustrating an algorithm for detecting the leave of a person according to the first embodiment.

FIG. 8 is a schematic block diagram illustrating a functional configuration example of a system processing unit according to the first embodiment.

FIG. 9 is a timing chart illustrating an example of the standby-state transition processing according to the first embodiment.

FIG. 10 is a flowchart illustrating an example of boot control according to the first embodiment.

FIG. 11 is a flowchart illustrating the example of the standby-state transition processing according to the first embodiment.

FIG. 12 is a timing chart illustrating an example of standby-state transition processing according to a second embodiment.

FIG. 13 is a flowchart illustrating the example of the standby-state transition processing according to the second embodiment.

### DETAILED DESCRIPTION OF THE INVENTION

Embodiments of the present invention will be described below with reference to the accompanying drawings.

### First Embodiment

[Outline]

First, the outline of an electronic apparatus 1 according to a first embodiment will be described. The electronic apparatus 1 according to the embodiment is, for example, a laptop PC (Personal Computer). Note that the electronic apparatus 1 may be an electronic apparatus of any other form, such as a desktop PC, a tablet terminal device, or a smartphone.

The electronic apparatus 1 can make a transition at least between a normal operating state (power-on state) and a standby state as system operating states. The normal operating state is an operating state capable of executing processing without being particularly limited, which corresponds, for example, to S0 state defined in the ACPI (Advanced Configuration and Power Interface) specification. The standby state is an operating state in which at least part of system processing is limited. For example, the standby state includes a state in which at least the display of a display unit appears to be OFF (screen OFF) or a screen lock state. The screen lock is a state in which an image preset to make a processed content invisible (for example, an image for the screen lock) is displayed on the display unit to indicate that the system is unusable until the lock is released (for example, user authentication is performed). For example, the standby state may be the standby state or a sleep state, or a state corresponding to modern standby in Windows (registered trademark) or S3 state (sleep state) defined in the ACPI specification. For example, the standby state is an operating state lower in power consumption than the normal operating state.

In the following, a transition of the system operating state from the standby state to the normal operating state may be called “boot.” In the standby state, since the activation level is generally lower than the normal operating state, the boot of the system of the electronic apparatus 1 leads to the activation of the operation of the system in the electronic apparatus 1.

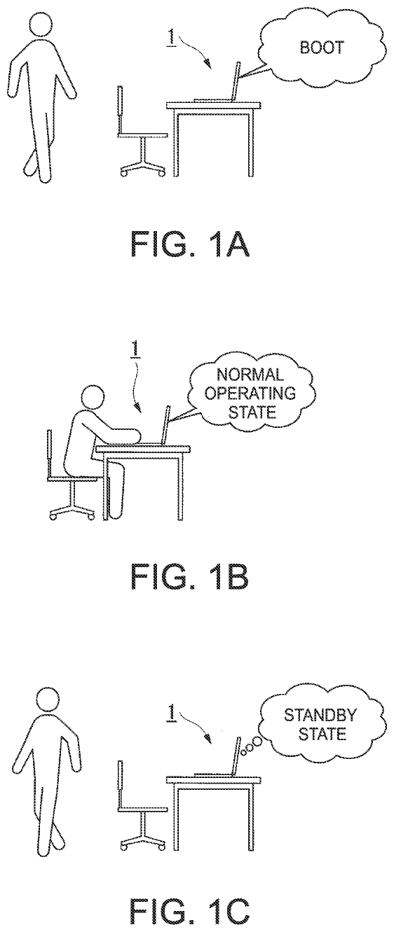

FIGS. 1A-1C are diagrams for describing an outline of HPD processing of the electronic apparatus 1 according to the embodiment. The electronic apparatus 1 includes a proximity sensor to be described later to detect a person present in the neighborhood of the electronic apparatus 1. This processing for detecting the presence of a person may also be called HPD (Human Presence Detection) processing. The electronic apparatus 1 detects a person present in the neighborhood of the electronic apparatus 1 to control the operating state of the system of the electronic apparatus 1 based on the detection result. For example, as illustrated in FIG. 1A, when detecting that a person approaches the electronic apparatus 1 (Approach), the electronic apparatus 1 automatically boots the system to make a transition to the normal operating state. Further, in a state where the person is present in front of the electronic apparatus 1 (Presence) as illustrated in FIG. 1B, the electronic apparatus 1 imposes such a restriction on the system so as not to make a transition to the standby state and to continue the normal operating state. Then, as illustrated in FIG. 1C, when detecting that the person has left the electronic apparatus 1 (Leave), the electronic apparatus 1 causes the system to make the transition to the standby state.

Here, the proximity sensor detects the distances to objects in the same way regardless of whether each object present in the neighborhood of the electronic apparatus 1 is a person or an object other than the person. For example, when an object present in the neighborhood of the electronic apparatus 1 is no longer detected or, when an object which has not been present is detected, the object is a moving object and can be roughly estimated as a person from the situation. On the other hand, when the electronic apparatus 1 is used in a small room, a box seat, or the like, a wall or the back of a chair may be present at a short distance even when the user leaves the electronic apparatus 1. In this case, since the proximity sensor continues detecting the distance to the object such as the wall or the back of the chair, there is a concern that a person leaving cannot be detected correctly. Therefore, the electronic apparatus 1 uses motion of the breast with breathing of a person to determine whether the proximity sensor detects a minute (small) distance variation caused by the motion of the breast or not in order to determine whether the object present in the neighborhood is the person or not. The processing for determining whether the object is the person or not from this minute (small) distance variation will be described in detail later.

In order to detect this minute distance variation, since there is a need to increase the detection cycle of the proximity sensor, power consumption increases. Therefore, in the normal operating state, the electronic apparatus 1 controls the proximity sensor in a mode for detecting the minute distance variation (hereinafter called the “high-accuracy detection mode”) to determine whether the object present in the neighborhood is the person or not in order to detect a person leaving the electronic apparatus 1. On the other hand, when the transition to the standby state is made as a result of detecting the person leaving, the electronic apparatus 1 controls the proximity sensor in a mode, in which the minute distance variation is not detected (hereinafter called the “sleep mode”), to reduce the detection cycle of the proximity sensor more than that in the “high-accuracy detection mode” in order to reduce power consumption.

In the meantime, the person (user) using the electronic apparatus 1 is not always staying neatly in front of the electronic apparatus 1 and tends to move freely. Therefore, there is a possibility to detect the leave of the person erroneously due to changes in posture of the person or the like despite the fact that the person is using the electronic apparatus 1, and hence to make the transition to the standby state. In such a case, since the minute distance variation cannot be detected after the proximity sensor makes a transition to the sleep mode, there is a case where the presence of the user cannot be detected by such a change that the user returns to an original posture or waves his or her hand lightly. Thus, it may not be easy to restore the electronic apparatus 1 from the standby state to the normal operating state.

Therefore, in the embodiment, the electronic apparatus 1 pre-notifies the user of the transition to the standby state before making the transition to the standby state. After that, when the presence of the person is not detected during a fixed period of time (for example, when the user does not return his or her posture or wave his or her hand lightly), the electronic apparatus 1 makes the transition to the standby state and causes the proximity sensor to make a transition from the “high-accuracy detection mode” to the “sleep mode.” This enables the electronic apparatus 1 to remind the user about the transition to the standby state by the pre-notification. Further, since the proximity sensor is operated in the “high-accuracy detection mode” during the fixed period of time for the pre-notification, the user can easily cancel the transition to the standby state.

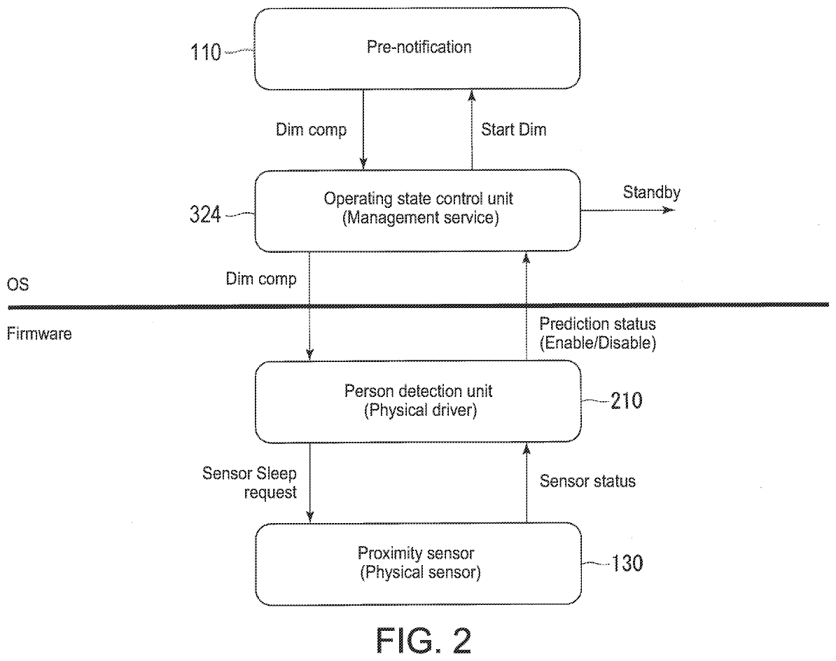

FIG. 2 is a diagram illustrating an outline of standby-state transition processing according to the embodiment. A proximity sensor 130 (Physical sensor) outputs, to a person detection unit 210 (Physical driver), a detection signal (Sensor status) according to the distance to an object present in the neighborhood of (in front of) the electronic apparatus 1. Based on the acquired distance detection signal, the person detection unit 210 takes a predetermined time (leave detection time) to determine the presence or absence of a person from the presence or absence of a minute distance variation or the like in order to detect the leave of the person. For example, the person detection unit 210 outputs a leave-predictive detection signal (Prediction status) to give the notification thereof at timing when it can be roughly predicted that the person has left within or in the middle of the leave detection time. For example, the leave-predictive detection signal includes flag information “1” indicative of Enable in a state where the leave of the person can be predicted or includes flag information “0” indicative of Disable in a state where the leave of the person cannot be predicted. The processing of the proximity sensor 130 and the person detection unit 210 is performed in processing by firmware.

Based on the detection result of the leave of a person, processing for pre-notification of the transition to the standby state and processing for making the transition to the standby state are performed, for example, in processing by an OS (Operating System) or processing by an application program running on the OS. When acquiring the leave-predictive detection signal (Enable) from the person detection unit 210, an operating state control unit 324 (Management service) performs pre-notification processing for pre-notifying the transition to the standby state (Pre-notification). For example, the operating state control unit 324 controls the display unit 110 to display a black image (or an image gradually turning black) on the display screen of the electronic apparatus 1 (Start Dim). Then, when a fixed time has elapsed after the start of the pre-notification (for example, 15 seconds), the operating state control unit 324 outputs, to the person detection unit 210, a pre-notification complete signal (Dim comp (complete)) indicative of completion of the pre-notification, and causes the system to make the transition from the normal operating state to the standby state (Standby). When acquiring the pre-notification complete signal (Dim comp), the person detection unit 210 outputs, to the proximity sensor 130, a request signal (Sensor Sleep request) for causing the detection mode of the proximity sensor 130 to make a transition to the “sleep mode” so that the proximity sensor 130 will make a transition from the “high-accuracy detection mode” to the “sleep mode.”

Next, the structure/configuration of the electronic apparatus 1 according to the embodiment will be described in detail.

[External Structure of Electronic Apparatus]

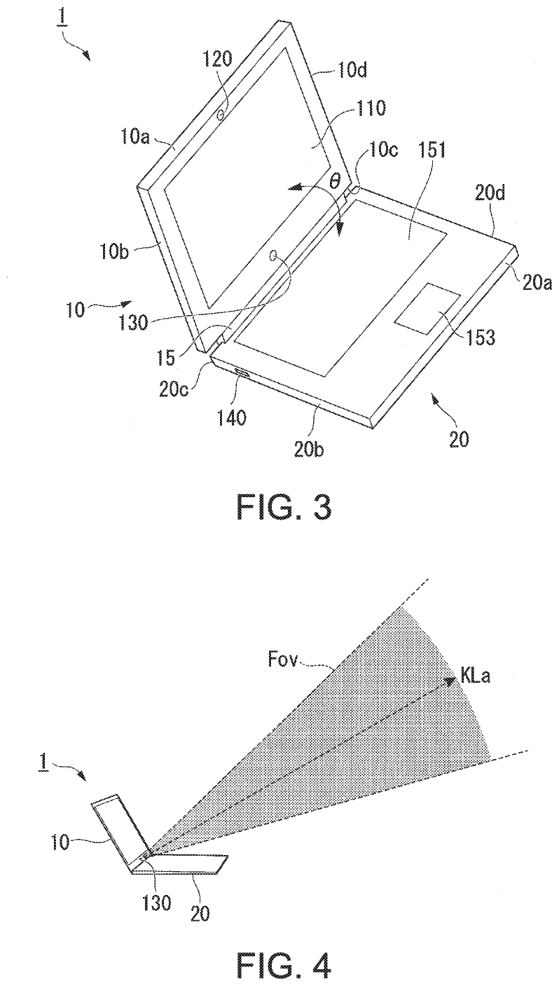

FIG. 3 is a perspective view illustrating an external structure example of the electronic apparatus 1 according to the embodiment.

The electronic apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. The direction of the axis of rotation is parallel to side faces 10c and 20c on which the hinge mechanism 15 is placed.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as the side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The right hand and left hand in the rearward direction are referred to as “right” and “left,” respectively. The left side faces of the first chassis 10 and the second chassis 20 are referred to as side faces 10b and 20b, respectively, and right side faces are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open is referred to as an “open state.”

The external appearance of the electronic apparatus 1 in FIG. 3 illustrates an example of the open state. The open state is a state where the side face 10a of the first chassis 10 and the side face 20a of the second chassis 20 are separated. In the open state, the inner faces of the first chassis 10 and the second chassis 20 appear so that the electronic apparatus 1 will be expected to be able to carry out normal operation. The open state is a state where the open angle θ between the inner face of the first chassis 10 and the inner face of the second chassis 20 is equal to or more than a predetermined angle, typically about 100° to 130°. Note that the range of open angles θ to be the open state can be set arbitrarily according to the range of angles rotatable by the hinge mechanism 15, or the like.

A display unit 110 is provided on the inner face of the first chassis 10. The display unit 110 is configured to include a liquid crystal display (LCD) or an organic EL (Electro Luminescence) display, and the like. Further, an imaging unit 120 and the proximity sensor 130 are provided in a peripheral area of the display unit 110 on the inner face of the first chassis 10. The imaging unit 120 is arranged on the side of the side face 10a in the peripheral area of the display unit 110. The proximity sensor 130 is arranged on the side of the side face 10c in the peripheral area of the display unit 110.

In the open state, the imaging unit 120 captures an image of an object within a predetermined angle of view in a direction (frontward) to face the inner face of the first chassis 10. The predetermined angle of view is an imaging angle of view defined by an image sensor included in the imaging unit 120 and an optical lens provided in front of an imaging surface of the image sensor.

The proximity sensor 130 detects an object (for example, a person) present in the neighborhood of the electronic apparatus 1. For example, the proximity sensor 130 is an infrared distance sensor configured to include a light-emitting part for emitting infrared light and a light-receiving part for receiving reflected light which is the infrared light returned after being emitted and reflected on the surface of the object. The proximity sensor 130 detects, with a predetermined sampling frequency (for example, 1 Hz), light received by the light-receiving part, and outputs a detection signal according to the distance to the object (for example, the person) by using a triangulation method for calculating the distance based on the imaging position of the received light or a ToF (Time of Flight) method for converting, to a distance, a time difference from light-emitting to light-receiving, or the like.

FIG. 4 is a schematic diagram illustrating a sensor detection range of the proximity sensor 130. In the open state, the proximity sensor 130 arranged on the inner face of the first chassis 10 detects an object (for example, a person) in a direction (frontward) to face the inner face of the first chassis 10. A detection field of view FoV indicates an angle detectable by the proximity sensor 130. A detection limit distance KLa indicates a limit distance detectable by the proximity sensor 130. A range defined by the detection field of view FoV (for example, 25° to 30°) and the detection limit distance KLa (for example, 120 cm) is the sensor detection range detectable by the proximity sensor 130.

Note that the proximity sensor 130 may be a sensor using infrared light emitted by a light-emitting diode, or a sensor using infrared laser emitting a light beam narrower in wavelength band than the infrared light emitted by the light-emitting diode. Further, the proximity sensor 130 is not limited to the infrared distance sensor, and it may be a sensor using any other method, such as an ultrasonic sensor or a sensor using an UWB (Ultra Wide Band) radar, as long as the sensor detects a distance to the object.

Returning to FIG. 3, a power button 140 is provided on the side face 20b of the second chassis 20. The power button 140 is an operating element used by the user to give instructions to boot the system (making a transition from the standby state to the normal operating state) and to make a transition from the normal operating state to the standby state. Further, a keyboard 151 and a touch pad 153 are provided as an input device on the inner face of the second chassis 20. Note that a touch sensor may be included as the input device instead of or in addition to the keyboard 151 and the touch pad 153, or a mouse and an external keyboard may be connected. When the touch sensor is provided, an area corresponding to the display surface of the display unit 110 may be configured as a touch panel for accepting operations. Further, a microphone used to input voice may be included in the input device.

In the closed state where the first chassis 10 and the second chassis 20 are closed, the display unit 110, the imaging unit 120, and the proximity sensor 130 provided on the inner face of the first chassis 10 are covered with the inner face of the second chassis 20, and put in a state of being disabled from fulfilling the functions thereof. In the state where the first chassis 10 and the second chassis 20 are completely closed, the open angle θ is 0′.

[Configuration of Electronic Apparatus]

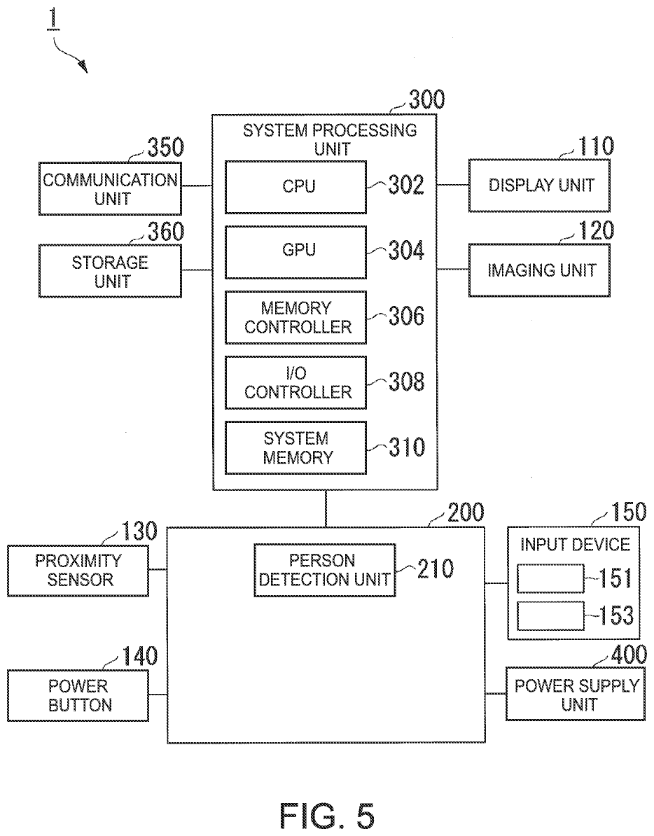

FIG. 5 is a schematic block diagram illustrating a configuration example of the electronic apparatus 1 according to the embodiment. The electronic apparatus 1 is configured to include the display unit 110, the imaging unit 120, the proximity sensor 130, the power button 140, an input device 150, an EC (Embedded Controller) 200, a system processing unit 300, a communication unit 350, a storage unit 360, and a power supply unit 400. The display unit 110 displays display data (images) generated based on system processing executed by the system processing unit 300, processing of an application program running in the system processing, and the like.

The imaging unit 120 captures an image of an object, within a predetermined angle of view in a direction (frontward), that is opposite (i.e., in front of) the inner face of the first chassis 10, and outputs the captured image to the system processing unit 300. For example, when the face of a person approaching the electronic apparatus 1 is contained within the angle of view of the imaging unit 120, the imaging unit 120 captures a face image of the person, and outputs the captured face image to the system processing unit 300. The imaging unit 120 may be an infrared camera or a normal camera. The infrared camera is a camera including an infrared sensor as an image sensor. The normal camera is a camera including, as an image sensor, a visible light sensor for receiving a visible light beam.

The proximity sensor 130 detects an object, (for example, a person) present in a direction (frontward), that is opposite (i.e., in front of) the inner face of the first chassis 10, and outputs, to the EC 200, a detection signal indicative of the detection result. The power button 140 outputs, to the EC 200, operation signals according to user's operations.

The input device 150 is an input unit for accepting user's input, which is configured to include, for example, the keyboard 151 and the touch pad 153. In response to accepting operations on the keyboard 151 and the touch pad 153, the input device 150 outputs, to the EC 200, operation signals indicative of the content of the operations.

The power supply unit 400 supplies power through a power system for supplying power to each unit of the electronic apparatus 1 according to the operating state of each unit. The power supply unit 400 includes a DC (Direct Current)/DC converter. The DC/DC converter converts the voltage of DC power, supplied from an AC (Alternate Current)/DC adapter or a battery pack, to a voltage required for each unit. The power with the voltage converted by the DC/DC converter is supplied to each unit through each power system. For example, the power supply unit 400 supplies power to each unit through each power system based on a control signal according to the operating state of each unit input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads software (control program) prestored in the ROM thereof and executes the read control program to fulfill the function. The EC 200 operates independently of the system processing unit 300 to control the operation of the system processing unit 300 and manage the operating state of the system processing unit 300. The EC 200 is connected to the proximity sensor 130, the input device 150, and the power supply unit 400.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the electronic apparatus 1. Further, the EC 200 acquires operation signals from the input device 150, and outputs, to the system processing unit 300, an operation signal related to processing of the system processing unit 300 among the acquired operation signals. Further, the EC 200 acquires a detection signal indicative of the detection result from the proximity sensor 130 to execute the HPD processing based on the detection result. For example, as a functional configuration related to the HPD processing, the EC 200 includes a person detection unit 210.

Based on the detection signal acquired from the proximity sensor 130, the person detection unit 210 detects a person (more specifically, an object estimated to be a person) present within a predetermined detection range. For example, based on the detection signal acquired from the proximity sensor 130, the person detection unit 210 detects a distance to the person present within the predetermined detection range in front of the electronic apparatus 1. The predetermined detection range is a range preset to detect a person in front of the electronic apparatus 1, which is referred to as a person detection range below. This person detection range is a range defined by the detection field of view indicative of the angle of view as a detection target and the maximum detection distance indicative of the distance as a detection target. For example, the person detection range corresponds to the sensor detection range of the proximity sensor 130. Specifically, for example, the detection field of view in the person detection range corresponds to the detection field of view FoV (see FIG. 4) of the proximity sensor 130. Further, for example, the maximum detection distance in the person detection range corresponds to the detection limit distance KLa of the proximity sensor 130 (see FIG. 4). Note that the person detection range may be such that a limitation on the maximum detection distance or the minimum detection distance is set as part of the sensor detection range of the proximity sensor 130. In other words, the person detection unit 210 may detect the person (distance to the person) by setting a preset range in the sensor detection range of the proximity sensor 130 as the person detection range.

For example, when acquiring a detection signal according to the distance to the person acquired from the proximity sensor 130, the person detection unit 210 detects that the person is present within the person detection range and detects the distance to the person. On the other hand, when the detection signal according to the distance to the person cannot be acquired from the proximity sensor 130, the person detection unit 210 detects that no person is present within the person detection range.

Further, when detecting a person after no person is detected within the person detection range, the person detection unit 210 determines that the person approaches in front of the electronic apparatus 1 and detects the approach of the person to the electronic apparatus 1. For example, when the approach of the person to the electronic apparatus 1 is detected, the person detection unit 210 outputs, to the system processing unit 300, an approach detection signal (Approach status) indicative of a statement to that effect. Further, when continuing to detect a person after detecting the person within the person detection range, the person detection unit 210 determines that the person is present in front of the electronic apparatus 1. Further, when no longer detecting the person after the person is detected within the person detection range, the person detection unit 210 determines that the person present in front of the electronic apparatus 1 has left and detects the person leaving the electronic apparatus 1.

Here, as described above, the person detection unit 210 may determine whether an object present within the person detection range is a person or not by determining whether there is a minute (small) distance variation caused by breathing of the person or not. For example, based on detection results in the “high-accuracy detection mode,” the person detection unit 210 takes a predetermined time to detect changes in distance changing according to breathing of the person present within the person detection range in order to detect whether the person is present within the person detection range or not.

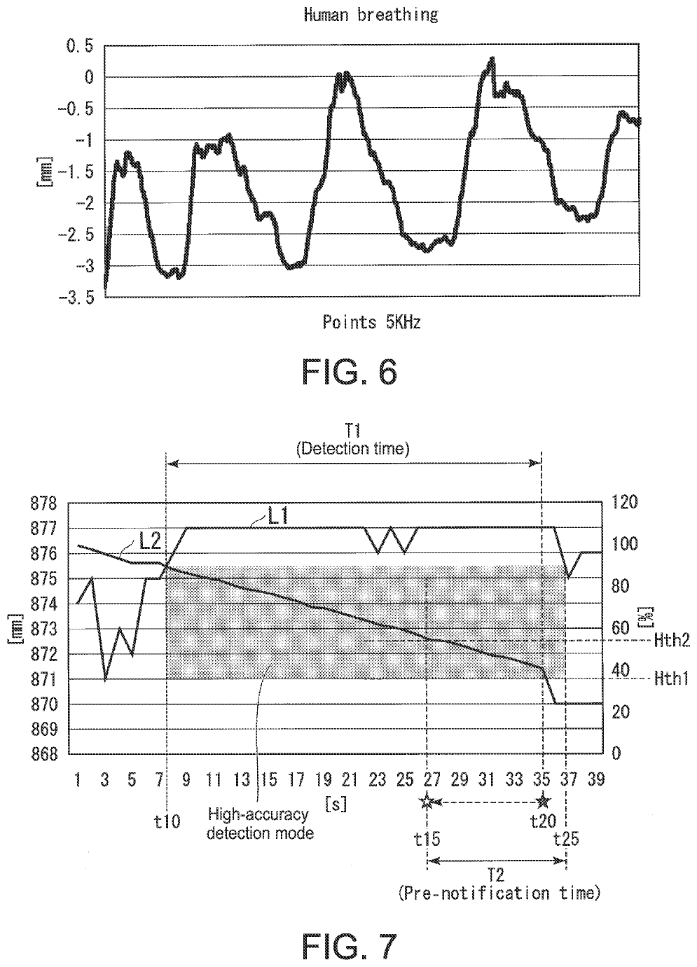

FIG. 6 is a graph illustrating an example of a distance variation associated with the breathing of a person (Human breathing). FIG. 6 illustrates an example of the results of measuring the distance to the breast of an opposed person with a sampling frequency of 5 kHz. Since the breast moves as the lungs repeat the cycles of expansion and contraction due to the breathing of the person, a minute (small) variation of about, for example, several millimeters occurs in the distance to the breast according to the cycle of breathing. Based on the detection signal acquired from the proximity sensor 130, the person detection unit 210 detects the presence or absence of a minute distance variation of about several millimeters generated according to the cycle of breathing of the person. When the object present in front of the electronic apparatus 1 is a person (opposed person), a minute distance variation generated according to the cycle of breathing of this person is detected. When the object present in front of the electronic apparatus 1 is any object other than the person (for example, the wall, the back of a chair, or the like), this minute distance variation is not detected. When this minute distance variation is detected, the person detection unit 210 determines that the object is the person, while when this minute distance variation is not detected, the person detection unit 210 determines that the object is any object other than the person. For example, the person detection unit 210 detects a change from a state where the person is present within the person detection range (Presence) to a state where the person is absent (that is, where the person has left (Leave)) based on the presence or absence of the minute distance variation mentioned above.

FIG. 7 is a graph illustrating an algorithm for detecting the leave of a person according to the embodiment. In FIG. 7, the line indicated by reference numeral L1 illustrates detection distance (mm) detected by the proximity sensor 130. The line indicated by reference numeral L2 illustrates the human occupancy probability (HOP) (%) of a person. For example, when there is a change in detection distance detected by the proximity sensor 13 in such a state that the person is being detected within the person detection range (for example, when the detection distance becomes far), the person detection unit 210 controls the proximity sensor 130 to enter the “high-accuracy detection mode” so as to detect the presence or absence of a minute distance variation caused by breathing of the person. The distance variation is minute. Therefore, when the minute distance variation is no longer detected after the presence of the person is being detected (for example, from a state where the human occupancy probability of the person is 100%), the person detection unit 210 starts subtraction from a preset value (budget), and detects that the person has left (Leave) at a time point (time t20) at which the human occupancy probability is decreased up to a predetermined threshold value Hth1 (for example, 35%) (confirms the detection of the leave). In other words, the person detection unit 210 takes detection time T1 from time t10 to time t20 to detect the leave of the person. For example, the detection time T1 from when the subtraction from this preset value (budget) is started to when the leave of the person is detected (when it is determined that the person has left) may be about, for example, 40 seconds at the maximum.

Further, the person detection unit 210 roughly predicts that the person has left at leave prediction timing (time t15) within or in the middle of the detection time T1 before confirming the detection of the person leaving. This leave prediction timing is, for example, timing at which the human occupancy probability (HOP) becomes a preset threshold value Hth2 (for example, 53%). Before the timing of confirming the person's leave (time t20), pre-notification is started in response to the leave prediction timing (time t15), and at timing (time t25) when a fixed time (pre-notification time T2) has elapsed after the start of the pre-notification, the person detection unit 210 switches the proximity sensor 130 from the “high-accuracy detection mode” to the “sleep mode.” The pre-notification time T2 is set to an amount of time equal to or more than the time required from the leave prediction timing (time t15) until the timing (time t20) of confirming the person's leave (for example, 15 seconds), but the user may be allowed to set the pre-notification time T2 arbitrarily.

The threshold value Hth2 (for example, 53%) at which the leave prediction timing is defined may be set to a different value, for example, depending on the slope of the human occupancy probability (HOP) or the like. Further, the person detection unit 210 may control the proximity sensor 130 to enter the “high-accuracy detection mode” at the timing of the start of the detection time T1, or may control the proximity sensor 130 to enter the “high-accuracy detection mode” before the detection time T1. Further, when the leave prediction timing is detected, the person detection unit 210 does not need to confirm the detection of the person leaving based on the detection signal acquired from the proximity sensor 130. For example, the person detection unit 210 may confirm the detection of the person leaving according to the lapse of the pre-notification time T2 after the leave prediction timing.

For example, the person detection unit 210, during the detection time T1, detects a change from a state where the person is present within the person detection range (Presence) to a state where the person is absent (i.e., the person has left (Leave)), and outputs the leave-predictive detection signal (Prediction status) to the system processing unit 300 at the leave prediction timing in the detection time T1. At the end of the detection time T1, the person detection unit 210 may output, to the system processing unit 300, a leave detection signal (Leave status) indicating that the leave of the person is confirmed. Further, when the presence of the person within the person detection range is detected during the time from when the leave-predictive detection signal is output to when the pre-notification time T2 has elapsed, the person detection unit 210 outputs, to the system processing unit 300, a presence detection signal (Presence status) indicating that the presence of the person is detected.

The proximity sensor 130 detects the distance to an object (for example, a person) present within the person detection range while switching between the “sleep mode” and the “high-accuracy detection mode” that is higher in detection accuracy (power consumption) than the “sleep mode.” The person detection unit 210 detects the leave of the person based on the detection results in the “high-accuracy detection mode” among the detection results of the proximity sensor 130. Further, after the lapse of the pre-notification time T2 since the leave-predictive detection signal was output (that is, when the presence of the person within the person detection range is not detected by the time the pre-notification time T2 passes), the person detection unit 210 outputs, to the proximity sensor 130, a request signal (Sensor Sleep request) for the transition of the detection mode of the proximity sensor 130 to the “sleep mode” to switch the detection mode of the proximity sensor 130 from the “high-accuracy detection mode” to the “sleep mode.”

Returning to FIG. 5, the system processing unit 300 is configured to include a CPU (Central Processing Unit) 302, a GPU (Graphic Processing Unit) 304, a memory controller 306, an I/O (Input-Output) controller 308, a system memory 310, and an authentication processing unit 321, where processes of various application programs are executable on an OS (Operating System) by system processing based on the OS. Note that the CPU 302 and the GPU 304 may be collectively called a processor.

The CPU 302 executes processes by the OS and processes by an application program(s) running on the OS. For example, the CPU 302 receives, from the EC 200, signals based on operations to the power button 140 and the input device 150 to control the operating state of the system. For example, when an operation signal is acquired from the power button 140 through the EC 200, the CPU 302 causes the operating state of the system to make a transition to the normal operating state or the standby state based on the acquired operation signal. For example, when an operation signal indicating that the power button 140 is pressed down in the standby state is acquired from the EC 200, the CPU 302 boots the system from the standby state. For example, in boot processing from a power-off (shutdown) state, the CPU 302 detects and initializes the minimum devices such as the system memory 310, the storage unit 360, and the like (pre-boot), and loads the OS program from the storage unit 360 into the system memory 310 to detect and initialize the other devices such as the communication unit 350 and the display unit 110 (post-processing). Initialization includes processing such as initial parameter settings. In the case of a transition (resume) from the sleep state to the normal operating state, part of the post-processing may be omitted. After completion of the boot processing, the CPU 302 starts execution of the system processing based on the OS (boot). For example, in the transition from the sleep state to the normal operating state, the CPU 302 resumes execution of an application program(s) the execution of which has been stopped in response to the transition to the sleep state.

In the boot processing, the CPU 302 may execute login processing to determine whether to allow access to the OS or not before the transition to the normal operating state. For example, when the boot processing by the OS is started, the CPU 302 executes the login processing before allowing access to the OS, and the transition to the normal operating state is paused until login is allowed in the login processing. In the login processing, user authentication processing is performed to determine whether the person using the electronic apparatus 1 is a preregistered, authorized user or not. As the authentication, there are password authentication, face authentication, fingerprint authentication, and the like. In the embodiment, an example of using face authentication processing will be described.

Further, when the operation signal indicating that the power button 140 is pressed down in the normal operating state is acquired, the CPU 302 causes the system to make a transition from the normal operating state to the standby state. More specifically, for example, when an operation signal indicating that the power button 140 is pressed down for a time shorter than a predetermined time is acquired in the normal operating state, the CPU 302 may cause the operating state of the system to make a transition to the sleep state, while when an operation signal indicating that the power button 140 is pressed down for a time longer than the predetermined time (long-press operation) is acquired, the CPU 302 may cause the system to make a transition to a shutdown state.

Further, when the duration of non-operation lasts for a preset time in the normal operating state, the CPU 302 may make a transition from the normal operating state to the standby state. This preset time is a threshold value for determining the transition to the standby state when the duration of non-operation has lasted, which is settable in the OS system settings. For example, when the duration of non-operation has lasted, there are options such as “screen OFF time” to determine a transition to a state where the display of the display unit 110 is turned OFF (screen OFF) and “sleep time” to determine a transition to the sleep state, and the user can select and set an option arbitrarily from among these options. In addition to time options (for example, “one minute,” “two minutes,” “four minutes,” “ten minutes,” “half-hour,” “one hour,”, a setting of prohibiting the transition to the screen OFF or a setting of prohibiting the transition to the sleep state (for example, “none”), and the like are also included.

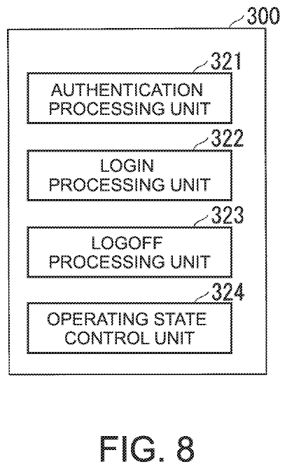

The CPU 302 further receives a signal based on the HPD processing from the EC 200 to control the operating state of the system. The details will be described later with reference to FIG. 8.

The GPU 304 is connected to the display unit 110. The GPU 304 executes image processing under the control of the CPU 302 to generate display data. The GPU 304 outputs the generated display data to the display unit 110. Note that the CPU 302 and the GPU 304 may be integrally formed as one core, or the load may be shared between the CPU 302 and the GPU 304 formed as individual cores, respectively. The number of processors is not limited to one, and it may be plural.

The memory controller 306 controls reading data from and writing data to the system memory 310, the storage unit 360, and the like, by the CPU 302 and the GPU 304.

The I/O controller 308 controls input/output of data from the communication unit 350, the display unit 110, and the EC 200.

The system memory 310 is used as a reading area of an execution program of the processor and a working area to write processed data.

The communication unit 350 is connected to other devices communicably through a wireless or wired communication network to send and receive various data. For example, the communication unit 350 is configured to include a wired LAN interface such as the Ethernet (registered trademark), a wireless LAN interface such as Wi-Fi (registered trademark), and the like.

The storage unit 360 is configured to include storage media, such as an HDD (Hard Disk Drive), a secure NVRAM (Non-Volatile RAM), a ROM (Read Only Memory), and the like. The HDD stores the OS, device drivers, various programs such as applications, and various data acquired by the operation of the programs. In the secure NVRAM, authentication data used to authenticate each user are stored. Stored in the authentication data are identification information of each user and authentication information in association with each other. The secure NVRAM is protected (locked) not to be able to be accessed from an OS operating environment via the I/O controller 308. Note, however, that the lock is released upon power-on and reset of the CPU 302, and the system firmware is executed upon completion of the pre-boot to start the lock.

Next, a functional configuration of operating state control processing executed by the system processing unit 300 will be described. FIG. 8 is a block diagram illustrating an example of the functional configuration of the system processing unit 300 according to the embodiment. As an example of the functional configuration executed by the CPU 302, the system processing unit 300 includes an authentication processing unit 321, a login processing unit 322, a logoff processing unit 323, and the operating state control unit 324. For example, the authentication processing unit 321, the login processing unit 322, and the logoff processing unit 323 are functional components implemented by the OS processing. Further, the operating state control unit 324 is a functional component implemented by the processing of an application program (for example, service program) running on the OS.

The authentication processing unit 321 executes face authentication processing based on a captured image output from the imaging unit 120. The face authentication processing includes face detection processing and face matching processing. The face detection processing is processing for defining a face area as an area of a face image from image data of the captured image output from the imaging unit 120. The face image is an image of the face of a person present in front of the electronic apparatus 1. Note that depth information acquired by the imaging unit 120 may be used in the authentication processing unit for face detection processing. The face matching processing has a step of determining the positions of plural face feature points (for example, mouth, eyes, nose, etc.) representing the features of the face from the face area, normalizing the position and size of the face area to be predetermined position and size, respectively, and defining a distribution of the normalized face feature points as image feature values, and a step of matching the defined image feature values with image feature values of the face image of a predetermined person to identify the person having image feature values with which matching is successful. In the storage unit 360, authentication information is set for each account as an authorized user who logs in with the account. The authentication information includes image feature values of the face image of the user. The authentication information is stored in further association with user information indicating the user. The user information may be information capable of identifying the user of the electronic apparatus 1, such as a user name, a user ID (Identifier), or the like.

As a result of matching the face image of the person captured by the imaging unit 120 with the authentication information on the set user, when it can be determined to match with each other, the authentication processing unit 321 determines that the face authentication is successful. On the other hand, for example, when a person other than the person using the electronic apparatus 1 cuts across in front of the electronic apparatus 1 by chance, the authentication processing unit 321 detects no face area from the image captured by the imaging unit 120. The authentication processing unit 321 outputs, to the login processing unit 322, the authentication result indicative of success/unsuccess of the face authentication.

The login processing unit 322 executes login processing to log in (allow the user to access the OS) based on the authentication result by the authentication processing unit. Specifically, in the boot processing, the login processing unit 322 instructs the authentication processing unit 321 to execute the face authentication processing before allowing access to the OS, and pauses the subsequent boot processing. When the authentication result by the authentication processing unit 321 is successful, the login processing unit 322 allows the login, and resumes the execution of the paused boot processing. On the other hand, when the authentication result by the authentication processing unit 321 is unsuccessful, the login processing unit 322 outputs such a notification as not to allow the login and leaves the execution of the boot processing paused.

The logoff processing unit 323 executes logoff processing to log off from the login state. For example, when receiving a logoff instruction (an instruction to make a transition to the standby state) with a user's operation, by the OS processing, by the HPD processing, or the like, the logoff processing unit 323 executes the logoff processing.

Based on the detection result by the person detection unit 210, the operating state control unit 324 controls the operating state of the system by the HPD processing. For example, when the approach detection signal indicating that the approach of the person to the electronic apparatus 1 is detected in the standby state is output from the person detection unit 210, the operating state control unit 324 boots the system in the standby state based on the approach detection signal. Further, in this case, the EC 200 outputs a control signal to the power supply unit 400 to supply power required to boot the system.

Further, in the normal operating state, when the leave-predictive detection signal is output from the person detection unit 210 at the leave prediction timing in the detection time T1 during which the leave of the person from the electronic apparatus 1 is detected by the person detection unit 210, the operating state control unit 324 performs pre-notification processing corresponding to the leave-predictive detection signal based on the leave-predictive detection signal.

Here, the pre-notification processing is processing for pre-notifying the leave of the person, for example, which is processing for turning the display into a black image display to make a display image displayed on the display unit 110 according to processing in the normal operating state invisible. Note that the operating state control unit 324 may display an image gradually turning black so that the display image according to the processing will be made gradually invisible. Specifically, the operating state control unit 324 may display, on the display unit 110, a black image by being superimposed on the display image according to the processing. The black image is an image of data in which the full screen area or a partial screen area is black, the transparency of which may be settable. When the image gradually turning black is displayed, the operating state control unit 324 provides a display by superimposing, on the display image according to the processing, a black image the transparency of which is gradually changed from 100% to 0%. Instead of providing the display by superimposing the black image on the display image according to the processing, the operating state control unit 324 may provide a black display by decreasing the display brightness of the display unit 110 (for example, backlight brightness in the case of a liquid crystal display (LCD)). Note that the pre-notification processing may be processing for displaying a pop-up screen or the like to display, on the display unit 110, information for notifying the transition to the standby state, or processing for voice-outputting, from a speaker (not illustrated) provided in the electronic apparatus 1, the information for notifying the transition to the standby state.

Further, when the fixed time (pre-notification time T2) has elapsed without detecting the presence of the person after the start of the pre-notification processing, the operating state control unit 324 outputs, to the person detection unit 210, a pre-notification complete signal indicative of completion of the pre-notification, and causes the operating state of the system to make the transition to the standby state. Further, in this case, the EC 200 outputs a control signal to the power supply unit 400 to stop the supply of power unnecessary in the standby state. When the presence detection signal indicating that the presence of the person is detected is output from the person detection unit 210 by the time the pre-notification time T2 passes, the operating state control unit 324 stops the pre-notification processing based on the presence detection signal to cause the operating state of the system not to make the transition to the standby state (that is, the pre-notification is canceled to continue the normal operating state).

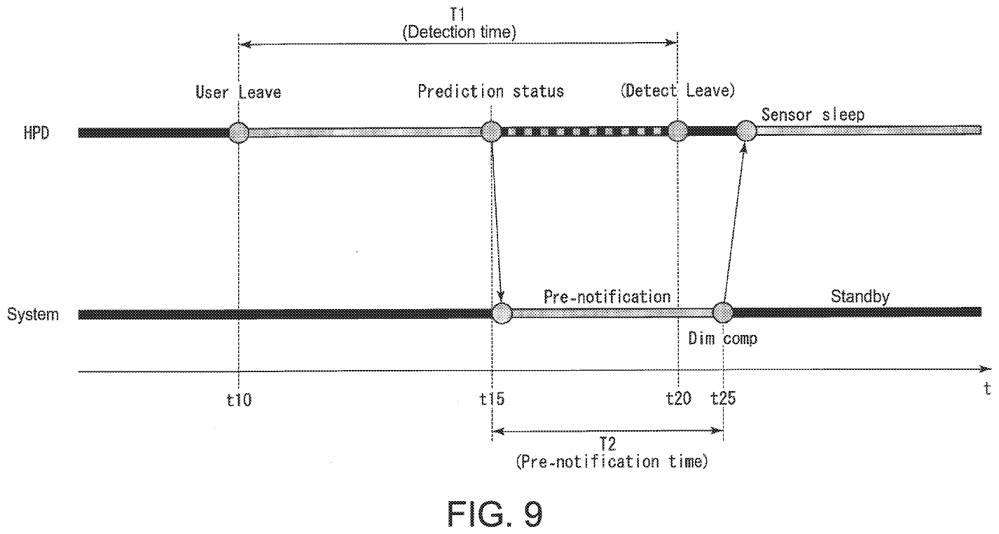

FIG. 9 is a timing chart illustrating an example of standby-state transition processing according to the embodiment. In FIG. 9, the upper part represents the HPD detection state and the lower part represents the operating state of the system by choosing the abscissa as time t. When the user leaves the electronic apparatus 1 at time t10 (User Leave), the person detection unit 210 of the EC 200 takes the detection time T1 (Detect time) from time t10 to time t20 to detect the leave of the person from the electronic apparatus 1 (Detect Leave) based on output of the proximity sensor 130. Here, the person detection unit 210 outputs, to the system processing unit 300, the leave-predictive detection signal at the leave prediction timing (time t15) in the detection time T1.

Based on the leave-predictive detection signal output from the person detection unit 210, the operating state control unit 324 performs the pre-notification processing for pre-notifying the transition to the standby state (Pre-notification). For example, as the pre-notification processing, the operating state control unit 324 performs processing for displaying a black image (or an image gradually turning black) on the display screen of the display unit 110. Then, when the fixed time (pre-notification time T2) has elapsed without detecting the presence of the person after the start of the pre-notification processing, the operating state control unit 324 outputs, to the person detection unit 210, the pre-notification complete signal (Dim comp) indicative of completion of the pre-notification at time t25, and causes the system to make the transition from the normal operating state to the standby state (Standby). When acquiring the pre-notification complete signal (Dim comp), the person detection unit 210 outputs, to the proximity sensor 130, the request signal (Sensor Sleep request) for the transition of the detection mode of the proximity sensor 130 to the “sleep mode” to cause the proximity sensor 130 to make the transition from the “high-accuracy detection mode” to the “sleep mode” (Sensor Sleep).

[Operation of Operating State Control Processing by HPD Processing]

Next, the operation of operating state control processing for controlling the operating state of the system by the HPD processing will be described. First, the operation of boot processing to boot the system when the EC 200 detects the approach of a person to the electronic apparatus 1 will be described.

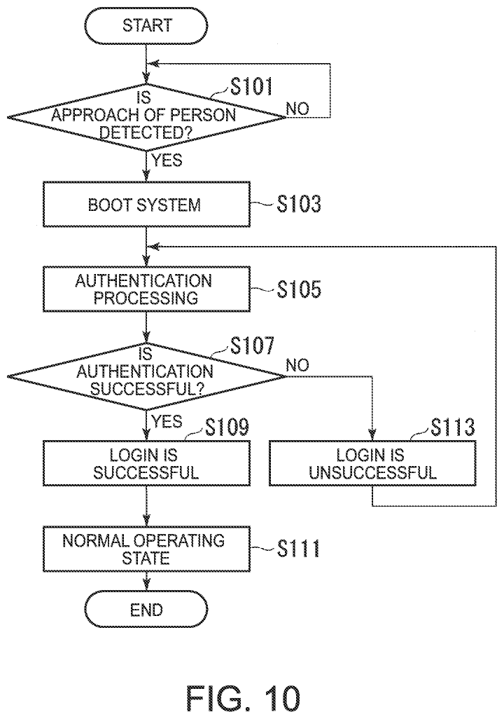

FIG. 10 is a flowchart illustrating an example of boot control according to the embodiment. Here, it is assumed that the electronic apparatus 1 is placed open on a desk or the like in the standby state.

(Step S101) Based on a detection signal acquired from the proximity sensor 130, the EC 200 determines whether the approach of a person to the electronic apparatus 1 is detected or not. When a person is detected after no person is detected within the person detection range, the EC 200 determines that the approach of a person to the electronic apparatus 1 is detected. When no person remains detected within the person detection range, the EC 200 determines that the approach of a person to the electronic apparatus 1 is not detected. Then, when determining that the approach of a person to the electronic apparatus 1 is not detected (NO), the EC 200 performs processing in step S101 again. On the other hand, when determining that the approach of a person to the electronic apparatus 1 is detected (YES), the EC 200 proceeds to processing in step S103.

(Step S103) The EC 200 boots the system. Specifically, when booting the system, the EC 200 outputs, to the power supply unit 400, the control signal to supply power necessary for the operation of each unit of the electronic apparatus 1. Further, the EC 200 outputs, to the system processing unit 300, the approach detection signal indicating that the approach of a person to the electronic apparatus 1 is detected. When acquiring the approach detection signal, the system processing unit 300 starts boot processing. Then, the procedure proceeds to processing in step S105.

(Step S105) The system processing unit 300 executes login processing (authentication processing). For example, the system processing unit 300 executes the login processing by face authentication based on a captured image acquired from the imaging unit 120, and proceeds to processing in step S107.

(Step S107) The system processing unit 300 determines whether the authentication result is successful or not. When determining that the authentication result is successful (YES), the system processing unit 300 proceeds to processing in step S109. On the other hand, when determining that the authentication result is unsuccessful (NO), the system processing unit 300 proceeds to processing in step S113.

(Step S109) When the authentication result is successful, the system processing unit 300 gives a notification that the login is successful (for example, displays the notification on the display unit 110) to continue the boot processing. Then, the procedure proceeds to processing in step S111.

(Step S111) The system processing unit 300 completes the login processing and makes a transition to the normal operating state.

(Step S113) When the authentication result is unsuccessful, the system processing unit 300 gives a notification that the login is unsuccessful (for example, displays the notification on the display unit 110), and returns to the authentication processing in step S105. When the authentication processing is unsuccessful continuously a predetermined number of times, the system processing unit 300 may stop the authentication processing and make a transition to a state of disabling the login.

Next, the operation of standby-state transition processing to cause the system to make the transition from the normal operating state to the standby state according to the fact that the EC 200 detects the leave of a person from the electronic apparatus 1 will be described.

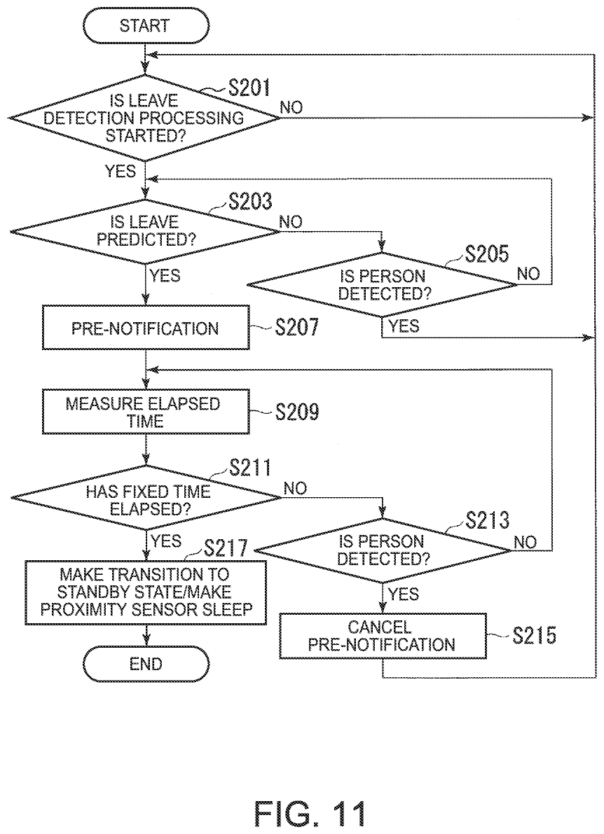

FIG. 11 is a flowchart illustrating an example of the standby-state transition processing according to the embodiment. Here, it is assumed that the electronic apparatus 1 is placed on the desk or the like in the open state and the operating state thereof is the normal operating state.

(Step S201) Based on the detection signal acquired from the proximity sensor 130, the EC 200 determines whether leave detection processing for detecting the leave of a person is started or not. When determining that the leave detection processing is started (YES), the EC 200 proceeds to processing in step S203. On the other hand, when determining that the leave detection processing is not started (NO), the EC 200 repeats processing in step S201.

(Step S203) The EC 200 determines whether it is the leave prediction timing or not. For example, when the human occupancy probability (HOP) becomes the preset threshold value Hth2 (for example, 53%) or less, the EC 200 determines that it is the leave prediction timing (YES), and outputs the leave-predictive detection signal (Prediction status) to the system processing unit 300. Then, the procedure proceeds to processing in step S207. On the other hand, when the human occupancy probability (HOP) is higher than the present threshold value Hth2 (for example, 53%), the EC 200 determines that it is not the leave prediction timing (NO), and the procedure proceeds to processing in step S205.

(Step S205) Based on the detection signal acquired from the proximity sensor 130, the EC 200 determines whether the presence of a person is detected or not. When determining that the presence of a person is detected (YES), the EC 200 pauses the leave detection processing and returns to the processing in step S201. On the other hand, when determining that the presence of a person is not detected (NO), the EC 200 returns to the processing in step S203.

(Step S207) When the leave-predictive detection signal is output from the EC 200, the system processing unit 300 performs the pre-notification processing for pre-notifying the transition to the standby state based on the leave-predictive detection signal. For example, as the pre-notification processing, the system processing unit 300 performs processing for displaying a black image (or an image gradually turning black) on the display screen of the display unit 110. Then, the procedure proceeds to processing in step S209.

(Step S209) The system processing unit 300 measures the elapsed time since the start of the pre-notification, and proceeds to processing in step S211.

(Step S211) The system processing unit 300 determines whether the fixed time has elapsed after the start of the pre-notification or not. For example, the system processing unit 300 determines whether the elapsed time since the start of the pre-notification reaches the pre-notification time T2 (for example, 15 seconds) or not. When determining that the elapsed time reaches the pre-notification time T2 (for example, 15 seconds) (the fixed time has elapsed) (YES), the system processing unit 300 outputs the pre-notification complete signal (Dim comp) to the EC 200, and proceeds to processing in step S217. On the other hand, when determining that the elapsed time since the start of the pre-notification does not reach the pre-notification time T2 (for example, 15 seconds) (NO), the system processing unit 300 proceeds to processing in step S213.

(Step S213) Based on the detection signal acquired from the proximity sensor 130, the EC 200 determines whether the presence of a person is detected or not. When the EC 200 determines that the presence of a person is not detected (NO), the procedure returns to the processing in step S209 in which the system processing unit 300 continues measuring the elapsed time. On the other hand, when the EC 200 determines that the presence of a person is detected (YES), the EC 200 outputs the presence detection signal to the system processing unit 300 and pauses the leave detection processing. Then, the procedure proceeds to processing in step S215.

(Step S215) The system processing unit 300 cancels the pre-notification. For example, the system processing unit 300 stops displaying the black image displayed on the display screen of the display unit 110 by the pre-notification processing. Then, the procedure returns to the processing in step S201.

(Step S217) When determining in step S211 that the fixed time has elapsed after the start of the pre-notification, the system processing unit 300 causes the system to make the transition from the normal operating state to the standby state. Further, the EC 200 outputs, to the proximity sensor 130, the request signal (Sensor Sleep request) for causing the detection mode of the proximity sensor 130 to make the transition to the “sleep mode” in order to switch the detection mode of the proximity sensor 130 from the “high-accuracy detection mode” to the “sleep mode.”

[Summary of First Embodiment]

As described above, the electronic apparatus 1 according to the embodiment includes the system processing unit 300, the person detection unit 210, and the operating state control unit 324. The system processing unit 300 executes system processing based on the system (for example, the OS). The person detection unit 210 takes the detection time T1 (an example of a first time) to detect a change from a first detection state in which a person is present within the person detection range (an example of a predetermined detection range) to a second detection state in which no person is present (that is, the person has left the electronic apparatus 1 (Leave)), and outputs the leave-predictive detection signal (an example of first detection information) at the leave prediction timing (an example of timing) in (for example, the middle of) the detection time T1. Based on the leave-predictive detection signal output from the person detection unit 210, the operating state control unit 324 performs pre-notification processing corresponding to the leave-predictive detection signal. For example, as the pre-notification processing, the operating state control unit 324 performs processing for displaying a black image (or an image gradually turning black) on the display screen of the display unit 110. Further, after the pre-notification time T2 (an example of a second time) has elapsed since the start of the pre-notification processing, the operating state control unit 324 causes the operating state of the system to make the transition to the standby state (an example of a first operating state) in which at least part of the system processing is limited.

Thus, when performing control to make the transition to the standby state according to the fact that the leave of a person from the electronic apparatus 1 is detected, the electronic apparatus 1 can perform pre-notification before the detection of the person's leave is confirmed to remind the user about the transition to the standby state. Further, since the electronic apparatus 1 performs the pre-notification and waits for a fixed time to make the transition to the standby state, the user can cancel the transition to the standby state before the transition to the standby state is made. Thus, the electronic apparatus 1 can control the operating state properly according to the presence or absence of a person.

Further, when the first detection state in which a person is present within the person detection range (the example of the predetermined detection range) is detected during the time from when the leave-predictive detection signal (the example of first detection information) is output to when the pre-notification time T2 (the example of the second time) has elapsed, the person detection unit 210 outputs the presence detection signal (an example of second detection information) indicating that the first detection state is detected. Then, based on the presence detection signal output from the person detection unit 210, the operating state control unit 324 stops the pre-notification processing and cancels the transition of the operating state of the system to the standby state (the example of the first operating state).

Thus, when the presence of a person is detected while pre-notification is being performed before the transition to the standby state, the electronic apparatus 1 can avoid the transition to the standby state.

Further, the proximity sensor 130 (an example of a distance sensor) can detect the distance to an object in respective detection modes of the “sleep mode” (an example of a first detection mode) and the “high-accuracy detection mode” (an example of a second detection mode) higher in detection accuracy (and higher in power consumption) than the “sleep mode.” Based on the detection results in the “high-accuracy detection mode,” the person detection unit 210 detects a change from the first detection state to the second detection state (i.e., that the person has left the electronic apparatus 1 (Leave)). Further, after the pre-notification time T2 (the example of the second time) has elapsed, the person detection unit 210 switches the detection mode of the proximity sensor 130 from the “high-accuracy detection mode” to the “sleep mode.”

Thus, since the detection accuracy of the presence or absence of the person by the proximity sensor 130 is high while the pre-notification is being performed before the transition to the standby state, the electronic apparatus 1 enables the user easily to cancel the transition to the standby state.

Further, based on the detection results in the “high-accuracy detection mode” (the example of the second detection mode), the person detection unit 210 takes the detection time T1 (the example of the first time) to detect changes in distance to the object changing according to breathing of a person present within the person detection range (the example of the predetermined detection range) in order to detect whether the person is present within the person detection range or not.

Thus, since the electronic apparatus 1 can detect a person in distinction from any object other than the person, the presence or absence of the person can be detected accurately, and hence the user can easily cancel the transition to the standby state.

For example, the end timing of the pre-notification time T2 (the example of the second time) is set later than the end timing of the detection time T1 (the example of the first time). In other words, it is set not to end the pre-notification so as to make the transition to the standby state before the timing of confirming the detection of the person's leave from the electronic apparatus 1.

Thus, the electronic apparatus 1 can keep the time constant from when the pre-notification is performed to when the transition to the standby state is made, and prevent the transition to the standby state before the detection of the person's leave is confirmed.

Note that the length of pre-notification time T2 (the example of the second time) may be settable by the user.

This enables the electronic apparatus 1 to vary the time from when the pre-notification is performed to when the transition to the standby state is made according to the user's favorite usage or the like.

In the embodiment, the example in which the operating state control unit 324 causes the operating state of the system to make the transition to the standby state according to the fact that the pre-notification time T2 has elapsed since the start of the pre-notification processing is described, but the present invention is not limited thereto. For example, the operating state control unit 324 may cause the operating state of the system to make the transition to the standby state according to the fact that the person detection unit 210 detects the leave of the person.

### Second Embodiment

Next, a second embodiment of the present invention will be described.

In the first embodiment, the pre-notification processing is performed in response to the leave prediction timing in the detection time T1 during which the leave of the person is detected, but the pre-notification processing may be performed in response to the end timing of the detection time T1 (that is, timing at which the detection of the person's leave is confirmed). Since the basic configuration of the electronic apparatus 1 according to this embodiment is the same as that illustrated in FIGS. 3, 4, 5, and 8, the description thereof will be omitted.

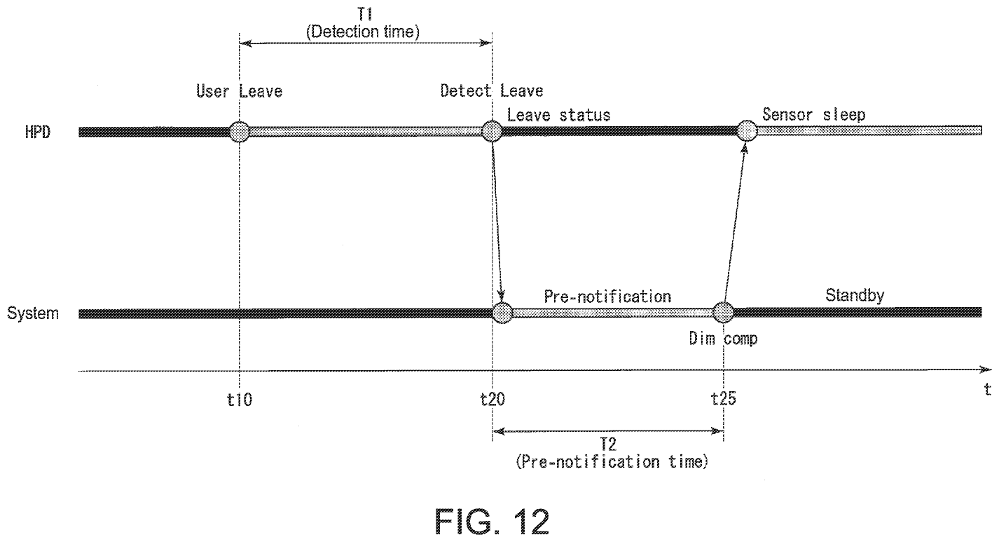

FIG. 12 is a timing chart illustrating an example of standby-state transition processing according to the embodiment. Like in FIG. 9, the upper part represents the HPD detection state and the lower part represents the operating state of the system by choosing the abscissa as time t in FIG. 12. When the user leaves the electronic apparatus 1 at time t10 (User Leave), the person detection unit 210 of the EC 200 takes the detection time T1 (Detect time) from time t10 to time t20 to detect the leave of the person from the electronic apparatus 1 (Detect Leave) based on output of the proximity sensor 130. Further, the person detection unit 210 outputs, to the system processing unit 300, the leave detection signal (Leave status) at the last timing of the detection time T1, that is, the timing of detecting the leave of the person (time t20).

The operating state control unit 324 of the system processing unit 300 performs the pre-notification processing for pre-notifying the transition to the standby state (Pre-notification) based on the leave detection signal output from the person detection unit 210. For example, as the pre-notification processing, the operating state control unit 324 performs processing for displaying a black image (or an image gradually turning black) on the display screen of the display unit 110. Then, when the fixed time (pre-notification time T2) has elapsed without detecting the presence of the person after the start of the pre-notification processing, the operating state control unit 324 outputs, to the person detection unit 210, the pre-notification complete signal (Dim comp) indicative of completion of the pre-notification at time t25, and causes the system to make the transition from the normal operating state to the standby state (Standby). When acquiring the pre-notification complete signal (Dim comp), the person detection unit 210 outputs, to the proximity sensor 130, the request signal (Sensor Sleep request) for the transition of the detection mode of the proximity sensor 130 to the “sleep mode” to cause the proximity sensor 130 to make the transition from the “high-accuracy detection mode” to the “sleep mode” (Sensor Sleep).

Next, the operation of operating state control processing according to the embodiment will be described. Note that the operation of boot processing is the same as the boot processing according to the first embodiment illustrated in FIG. 10.

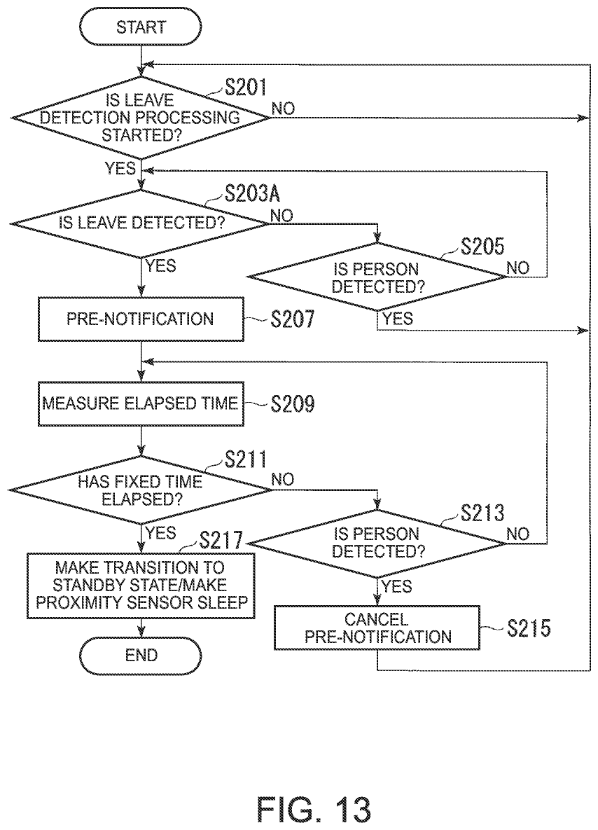

FIG. 13 is a flowchart illustrating an example of standby-state transition processing according to the embodiment. In FIG. 13, the same processing step as each processing step illustrated in FIG. 11 is given the same reference numeral. The standby-state transition processing according to the embodiment is different in processing step S203A from the standby-state transition processing illustrated in FIG. 11.

(Step S203A) The EC 200 determines whether the leave of the person is detected or not. For example, when the human occupancy probability (HOP) becomes the preset threshold value Hth1 (for example, 35%) or less, the EC 200 determines that the leave of the person is detected (the detection of the leave is confirmed) (YES), and outputs the leave detection signal (Leave status) to the system processing unit 300. Then, the procedure proceeds to processing in step S207. On the other hand, when the human occupancy probability (HOP) is higher than the preset threshold value Hth1 (for example, 35%), the EC 200 determines that the leave of the person is being detected (that is, the detection of the leave is not confirmed yet) (NO), the procedure proceeds to processing in step S205. Since the other processing is the same as the processing illustrated in FIG. 11, the description thereof will be omitted.

[Summary of Second Embodiment]

As described above, the electronic apparatus 1 according to the embodiment includes the system processing unit 300, the proximity sensor 130, the person detection unit 210, and the operating state control unit 324. The system processing unit 300 executes system processing based on the system (for example, the OS). The proximity sensor 130 detects the distance to an object in respective detection modes, that is, the “sleep mode” (the example of the first detection mode) and the “high-accuracy detection mode” (the example of the second detection mode) higher in detection accuracy (and higher power consumption) than the “sleep mode.” Based on the detection results in the “high-accuracy detection mode,” the person detection unit 210 detects a change from the first detection state in which a person is present within the person detection range (the example of the predetermined detection range) to the second detection state in which no person is present (that is, that the person has left the electronic apparatus 1 (Leave)), and outputs the leave detection signal (the example of the detection information) based on the detection. Based on the leave detection signal output from the person detection unit 210, the operating state control unit 324 performs pre-notification processing corresponding to the leave-predictive detection signal. After the pre-notification time T2 (the example of the second time) has elapsed since the start of the pre-notification processing, the operating state control unit 324 causes the operating state of the system to make the transition to the standby state (the example of the first operating state) in which at least part of the system processing is limited. Further, after the pre-notification time T2 has elapsed, the person detection unit 210 switches the detection mode of the proximity sensor 130 from the “high-accuracy detection mode” to the “sleep mode.”

Thus, since the electronic apparatus 1 makes the transition to the standby state after performing pre-notification according to the fact that the leave of the person from the electronic apparatus 1 is detected, the electronic apparatus 1 can remind the user about the transition to the standby state before making the transition to the standby state. Further, since the detection accuracy of the presence or absence of the person by the proximity sensor 130 is high while the pre-notification is being performed before the transition to the standby state, the electronic apparatus 1 enables the user easily to cancel the transition to the standby state. Thus, the electronic apparatus 1 can control the operating state properly according to the presence or absence of a person.

<Variations>

While the first and second embodiments of this invention have been described in detail above with reference to the accompanying drawings, the specific configuration is not limited to the above-described embodiments, and design changes shall be included without departing from the scope of this invention. For example, respective components described in the above-described embodiments can be combined arbitrarily.

In the above embodiments, the example in which the operating state control unit 324 outputs the pre-notification complete signal (Dim comp) to the person detection unit 210 when the fixed time (pre-notification time T2) has elapsed without detecting the presence of a person after the start of the pre-notification has been described, but this pre-notification complete signal does not have to be output. For example, the person detection unit 210 may measure the pre-notification time T2 or a time equivalent to the pre-notification time T2. For example, the person detection unit 210 may measure the elapsed time since the leave-predictive detection signal or the leave detection signal was output to the system processing unit 300 to switch the detection mode of the proximity sensor 130 from the “high-accuracy detection mode” to the “sleep mode” according to the fact that the elapsed time reaches the pre-notification time T2 (for example, 15 seconds).

In the above embodiments, the example in which the person detection unit 210 detects a person (more specifically, an object estimated to be a person) present within the person detection range based on the detection signal (that is, the distance to the object) acquired from the proximity sensor 130 has been described, but the person detection method is not limited thereto. For example, the person detection unit 210 may detect a person or the face of the person from a captured image acquired by the imaging unit 120 to detect the person present within the person detection range.

Further, in the above embodiments, the configuration example in which the imaging unit 120 is incorporated in the electronic apparatus 1 has been described, but the configuration is not limited thereto. For example, the imaging unit 120 does not have to be incorporated in the electronic apparatus 1, which may be connected to the electronic apparatus 1 wirelessly or by wire as an external accessory.

Further, in the above embodiments, the EC 200 configured to operate independently of the system processing unit 300 may be any processing unit such as a sensor hub or a chipset, and the above-described processing may be executed by any processing unit other than the EC 200 instead of the EC 200. It is usually the case that the sum of power consumption of the processing unit such as this EC 200 and the proximity sensor 130 is significantly less than the power consumption of the system processing unit 300.

Further, in the standby state described above, a hibernation state, a power-off state, or the like may also be included. The hibernation state corresponds, for example, to S4 state defined in the ACPI specification. The power-off state corresponds, for example, to S5 state (shutdown state) defined in the ACPI specification.

Note that the electronic apparatus 1 described above has a computer system therein. Then, a program for implementing the function of each component included in the electronic apparatus 1 described above may be recorded on a computer-readable recording medium so that the program recorded on this recording medium will be read into the computer system and executed to perform processing in each component included in the electronic apparatus 1 described above. Here, the fact that “the program recorded on the recording medium is read into the computer system and executed” includes installing the program on the computer system. It is assumed that the “computer system” here includes the OS and hardware such as a peripheral device and the like. Further, the “computer system” may also include two or more computers connected through a network including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. The recording medium with the program stored thereon may be a non-transitory recording medium such as the CD-ROM.

A recording medium internally or externally provided to be accessible from a delivery server for delivering the program is included as the recording medium. Note that the program may be divided into plural pieces, downloaded at different timings, respectively, and then united in each component included in the electronic apparatus 1, or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the functions of the electronic apparatus 1 in the above-described embodiments may be realized as an integrated circuit such as LSI (Large Scale Integration). Each function may be a processor implemented individually, or part or whole thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the electronic apparatus 1 in the above-described embodiments is not limited to a PC, a tablet terminal, or a smartphone, and the present invention can also be applied to a household electric appliance or a commercial electric appliance. As the household electric appliance, the present invention can be applied to a TV set, a refrigerator or a microwave oven having a display unit, or the like. For example, ON/OFF of a TV screen or ON/OFF of a screen of the display unit of the refrigerator or the microwave oven can be controlled in response to the approach or leave of a person. As the commercial electric appliance, the present invention can be applied to a vending machine, a multimedia station, or the like. For example, an operating state such as ON/OFF of lighting of the vending machine or ON/OFF of a screen of a display unit of the multimedia station can be controlled in response to the approach or leave of a person.

1. An electronic apparatus comprising:
a system processing unit which executes system processing based on a system;
a person detection unit which takes a first time to detect a change from a first detection state in which a person is present within a predetermined detection range to a second detection state in which no person is present, and outputs first detection information during the first time; and
an operating state control unit which performs pre-notification processing corresponding to the first detection information output from the person detection unit, and causes an operating state of the system to make a transition to a first operating state, in which at least part of the system processing is limited, after a second time has elapsed since the start of the pre-notification processing.

2. The electronic apparatus according to claim 1, wherein
when detecting the first detection state in which the person is present within the predetermined detection range during a period of time from outputting the first detection information until the second time has elapsed, the person detection unit outputs second detection information indicating that the first detection state is detected, and
based on the second detection information output from the person detection unit, the operating state control unit stops the pre-notification processing and cancels the transition of the operating state of the system to the first operating state.

3. The electronic apparatus according to claim 1, wherein
the person detection unit has a distance sensor that detects distance from the person detection unit to an object in a first detection mode and a second detection mode that is higher in detection accuracy than the first detection mode,
the person detection unit detects a change from the first detection state to the second detection state based on detection results in the second detection mode, and
after the second time has elapsed, the person detection unit switches the detection mode of the distance sensor from the second detection mode to the first detection mode.

4. The electronic apparatus according to claim 3, wherein the person detection unit, during the first time, detects changes in a distance changing according to breathing of the person present within the predetermined detection range based on the detection results in the second detection mode in order to detect whether the person is present within the predetermined detection range or not.

5. The electronic apparatus according to claim 1, wherein and end of the second time is set later than an end of the first time.

6. The electronic apparatus according to claim 1, wherein a length of the second time is settable by a user.

7. An electronic apparatus comprising:
a system processing unit which executes system processing based on a system;
a person detection unit having a distance sensor capable of detecting distance from the person detection unit to an object, in a first detection mode and a second detection mode that is higher in detection accuracy than the first detection mode, to detect, based on detection results in the second detection mode, a change from a first detection state in which a person is present within a predetermined detection range to a second detection state in which no person is present, and output detection information based on the detection; and
an operating state control unit which performs pre-notification processing corresponding to the detection information output from the person detection unit, and causes an operating state of the system to make a transition to a first operating state, in which at least part of the system processing is limited, after a second time has elapsed since the start of the pre-notification processing,
wherein the person detection unit switches the detection mode of the distance sensor from the second detection mode to the first detection mode after the second time has elapsed.

8. A control method for an electronic apparatus that includes a system processing unit which executes system processing based on a system, the control method comprising:
a person detection step of causing a person detection unit, during a first time, to detect a change from a first detection state in which a person is present within a predetermined detection range to a second detection state in which no person is present, and to output first detection information during the first time; and
an operating state control step of causing an operating state control unit to perform pre-notification processing corresponding to the first detection information output in the person detection step, and to cause an operating state of the system to make a transition to a first operating state, in which at least part of the system processing is limited, after a second time has elapsed since the start of the pre-notification processing.

9. A control method for an electronic apparatus that includes: a system processing unit which executes system processing based on a system; and a distance sensor capable of detecting distance from the system processing unit to an object in a first detection mode and a second detection mode that is higher in detection accuracy than the first detection mode, the control method comprising:
a person detection step of causing a person detection unit to detect a change from a first detection state in which a person is present within a predetermined detection range to a second detection state in which no person is present based on detection results in the second detection mode, and to output detection information based on the detection to the system processing unit; and
an operating state control step of causing an operating state control unit to perform pre-notification processing corresponding to the detection information based on the detection information output in the person detection step, and to cause an operating state of the system to make a transition to a first operating state, in which at least part of the system processing is limited, after a second time has elapsed since the start of the pre-notification processing,
wherein, in the person detection step, the detection mode of the distance sensor is switched from the second detection mode to the first detection mode after the second time has elapsed.
